(19) United States
(12) Patent Application Publication
(10) Pub. No.: US 2004/0103118 A1
(43) Pub. Date: May 27, 2004

(54) Method and system for multi-level monitoring and filtering of electronic transmissions

(76) Inventors: John Irving, Ottowa (CA); Marcello Bursztein, Ottowa (CA); Steve Mulligan, Ottowa (CA); Patrick Lajeunesse, Ottowa (CA)

Correspondence Address: JAMES D. FORNARI ESQ, SUITE 3-A, 1020 PARK AVENUE, NEW YORK, NY, 10022, US

(21) Appl. No.: 10/619,097

(22) Filed: Jul. 14, 2003

Related U.S. Application Data
(60) Provisional application No. 60/395,407, filed on Jul. 13, 2002.

(51) Int. Cl. G06F 17/00

(52) U.S. Cl. 707/104.1

(57) ABSTRACT

The present invention is a method and apparatus for multi-level monitoring and filtering of data transmission (SchoolMail) to permit a school district or other affinity group to create a secure “virtual classroom”, “Virtual district” or “Virtual affinity group” and multiple accounts to permit a hierarchical infrastructure with varying privileges associated with each user name or category. The system provides a universal solution to allowing information flow to both students and educators, or varying participant levels within a group, while maintaining control of the type and character of material received and sent. The system can employ common service capability to permit multiple districts or user groups to have their individual SchoolMail, while at the same time providing the capability for interaction and connectivity among the districts, based upon screening and search criteria. It also permits internal community or group generation to permit the dissemination of information to different levels of educators or administrators on a needs basis.

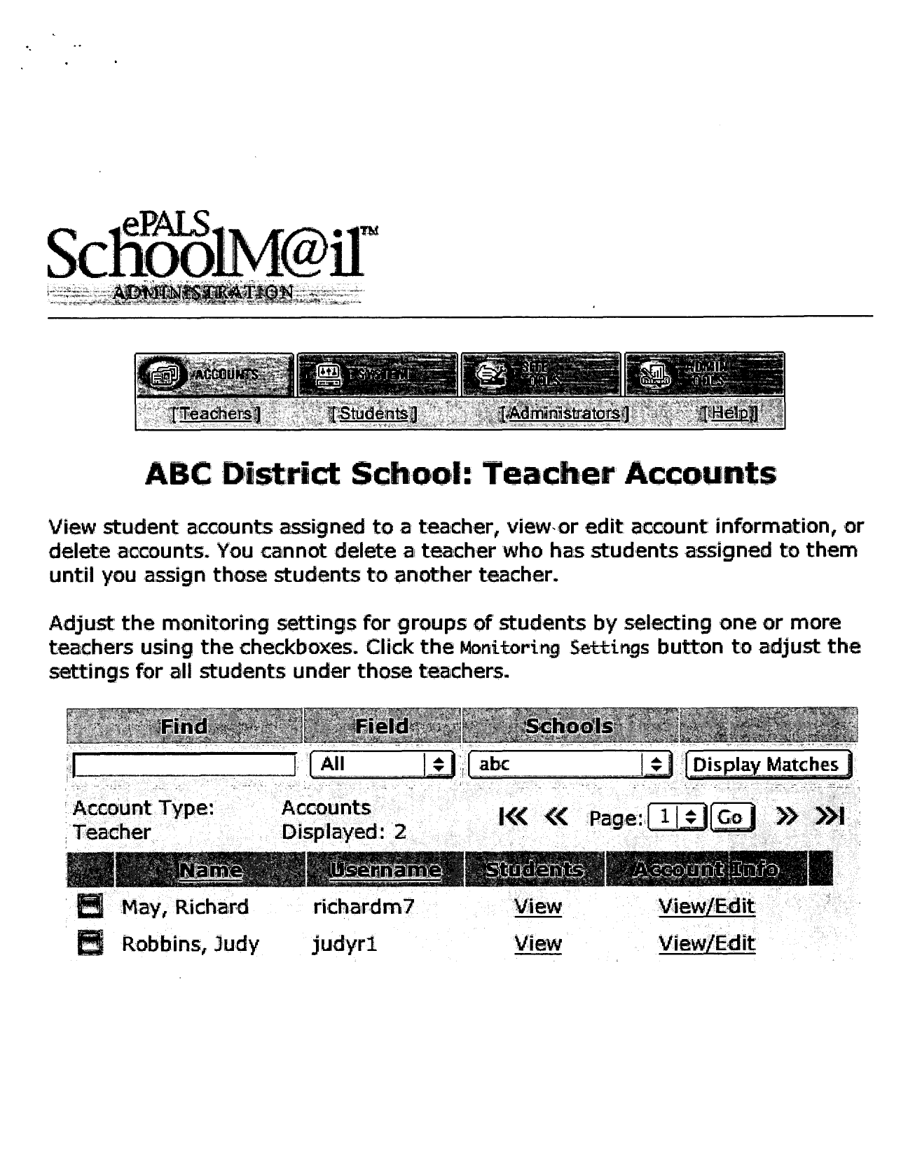

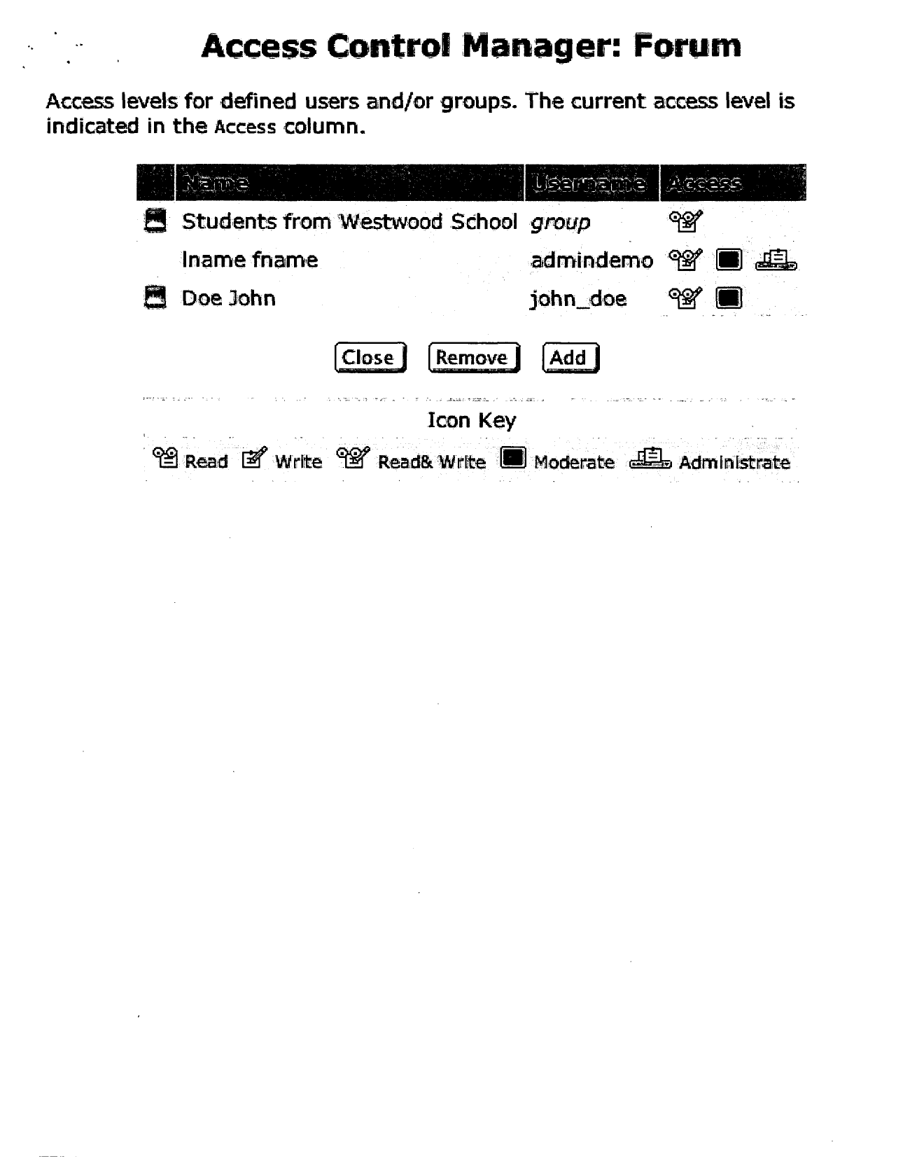

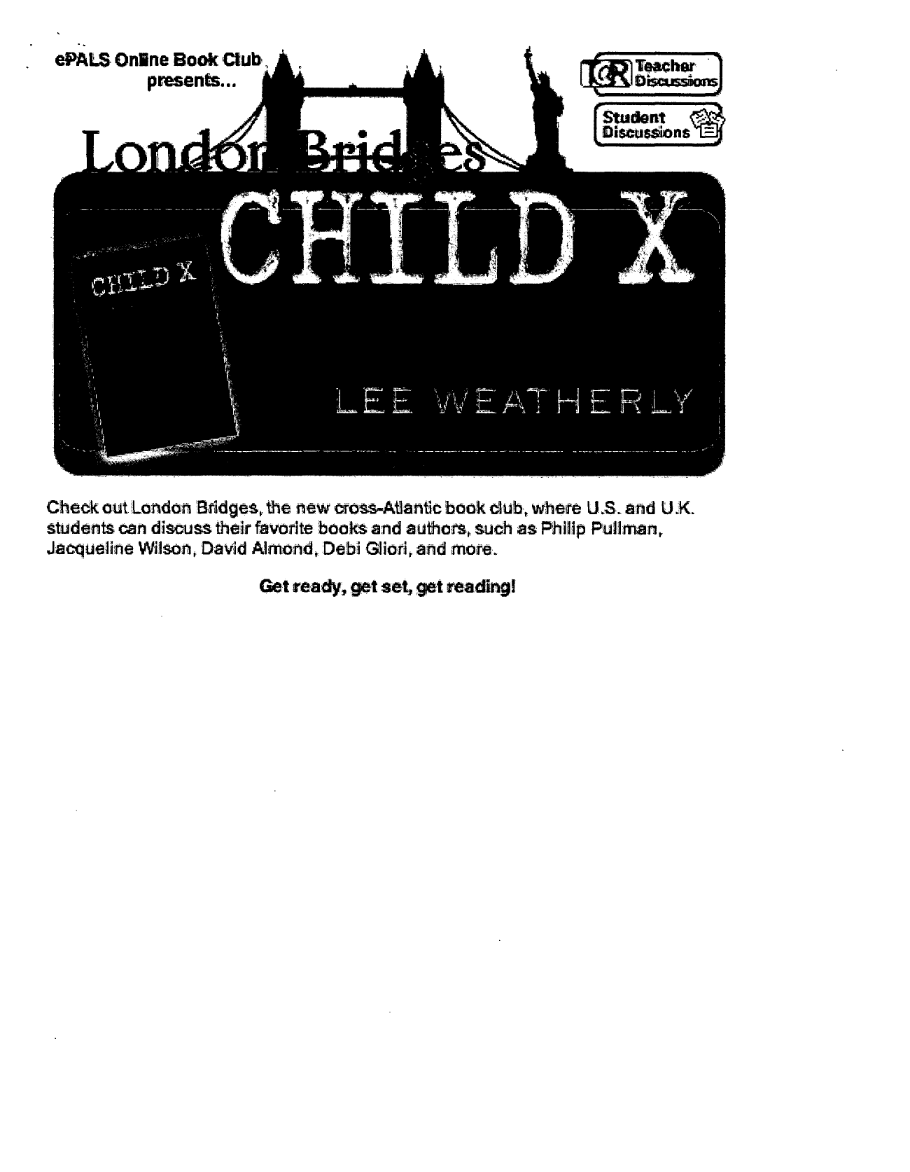

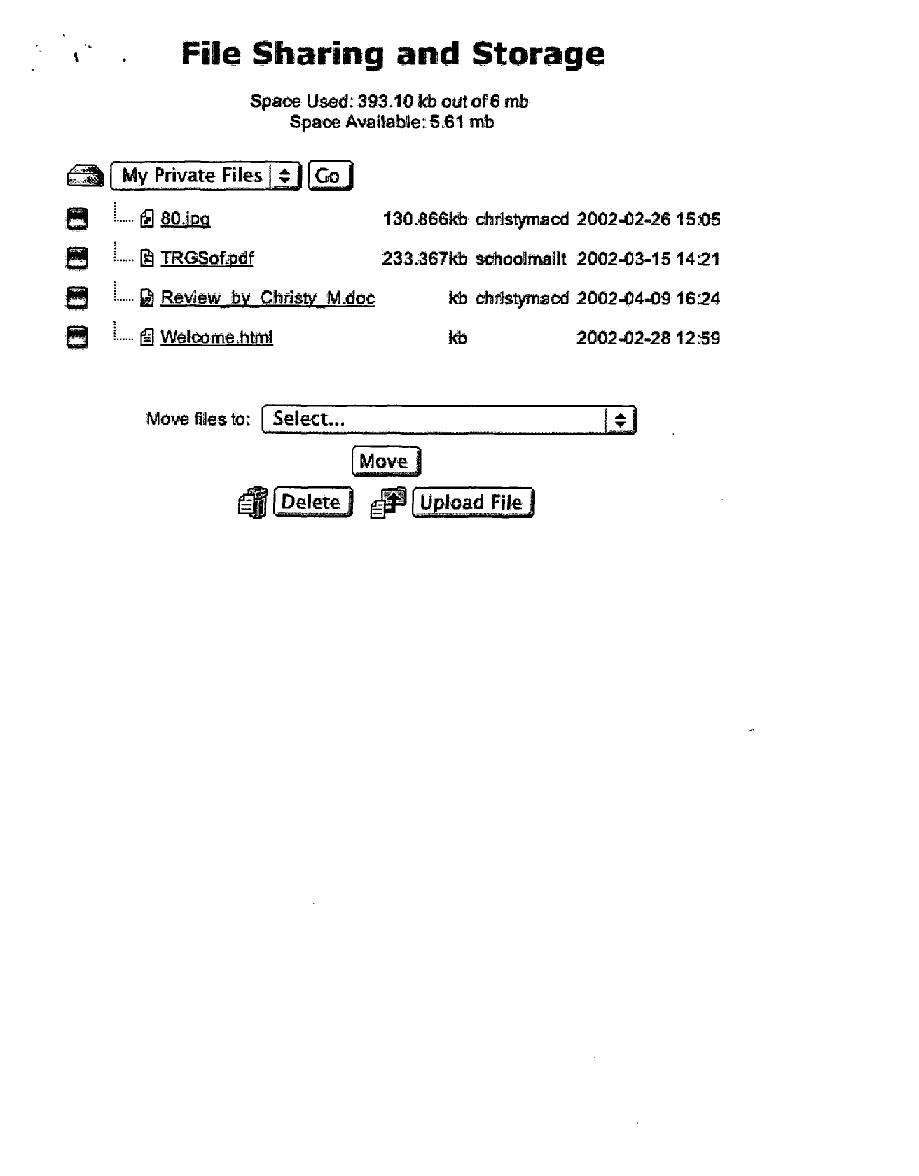

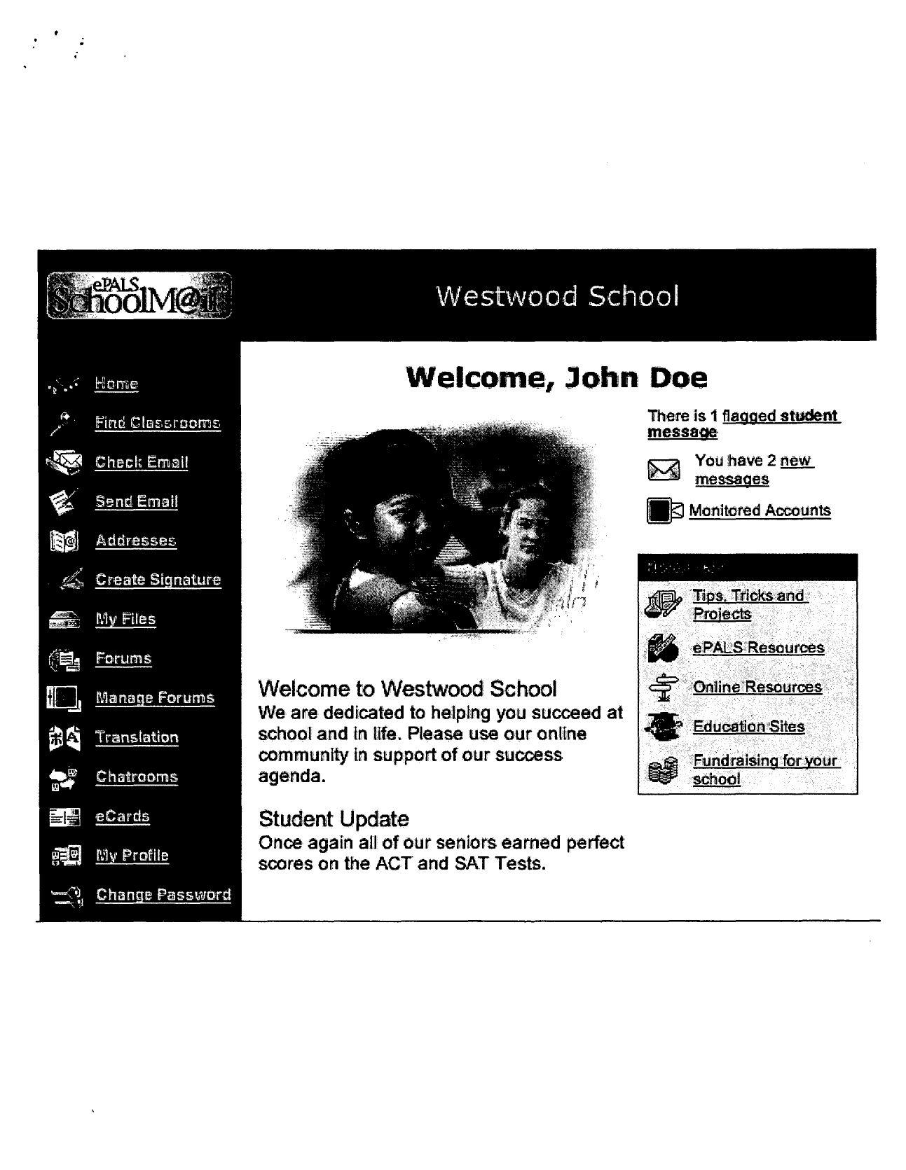

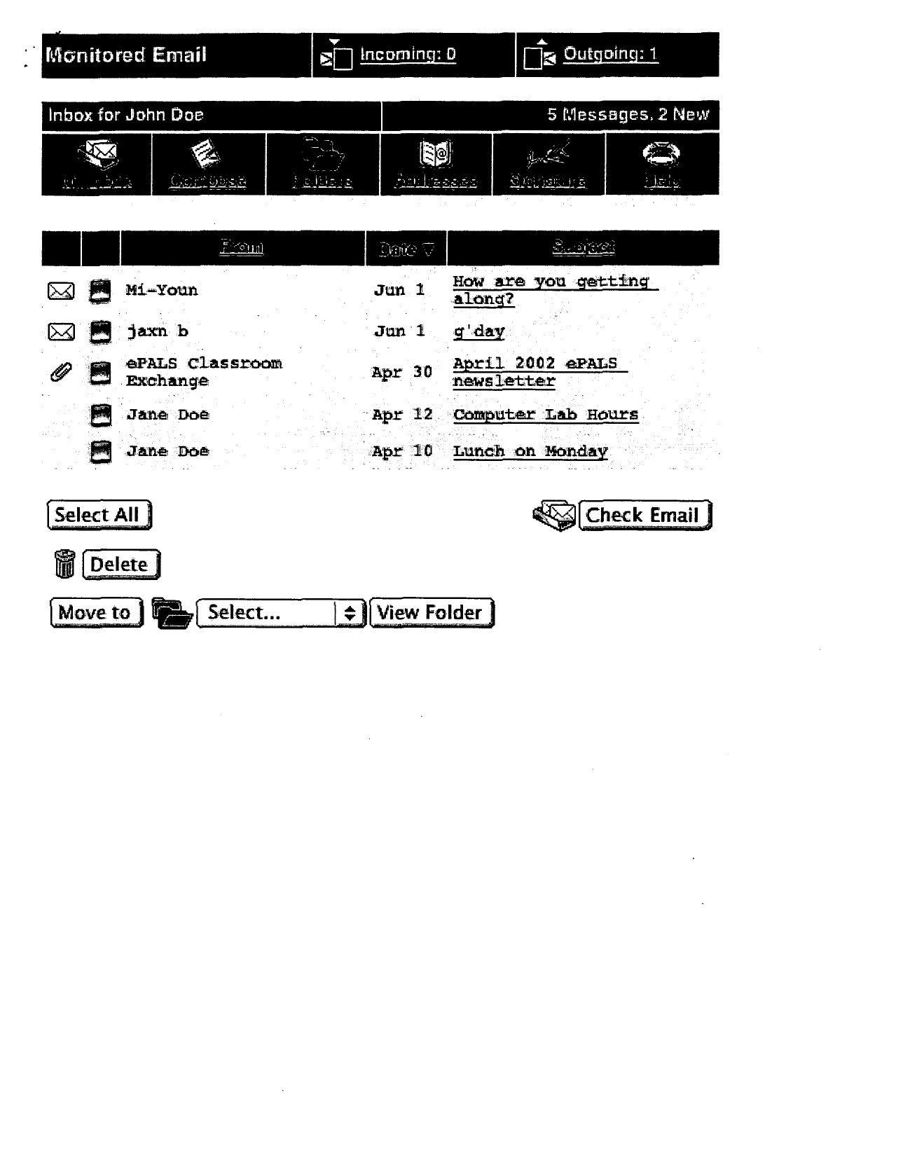

### BACKGROUND OF THE INVENTION

Globalization has become the watchword both in commerce and education. A company that does not look beyond its own borders, be those the town in which it is located or the country in which it principally operates, is at a disadvantage. It will not be able to take advantage of opportunities that are available, may not be able to maximize its productivity and could well perform at sub-optimal levels because of inadequate information and data flow. The same is true in education. Children who do no integrate technology into their learning experience will be foreclosed from future opportunities. Unless children learn, at an early age, that there is a world with different views all of which may have validity within the context of the environment in which the views are held, they may well be unable to assimilate into the world and contribute to changing views. Life today is not a microcosm. It requires a global approach.

In the past, there were a limited number of school that could provide the breathe of information necessary to allow students to expand beyond the confine of the community, state or country. Technology arrived that permitted a small number of school, with advanced capabilities to communicate with one another and allowed teacher and students who were thousands of miles apart to share information, thoughts and projects. Yet the teachers within these schools were often limited in their ability to communicate with other teachers. Communication systems using e-mail required that the teachers sharing information be on the same or compatible systems. Many teachers were not sufficiently literate in computer technology to use e-mail, much less integrate it into their lessons plans and projects. Hopeful participants often had little way of finding others who were interested in an exchange of information or desirous of collaborative activities. The process required extensive work to establish the most rudimentary interaction and collaboration. And yet the world continued to expand and the information derived therefrom continued to explode, both in quantity and quality.

Global education became a requirement, not a luxury. Technology integration into a curriculum became a must. The Internet has become the transmission medium. Connectivity has become the goal. The proliferation of personal computers has permitted virtually every classroom to have the capability to be “wire” and on-line. There is the realization that Internet connectivity can enhance the economic advancement of students and communities and provide a level of information on a broad scale hitherto unknown. In can permit the current generation to leap frog into this century. The failure to provide such connectivity can further exacerbate the split between the haves and the have-nots.

Along with global information access has come the realization that a level of monitoring and control must be exercise in order to keep the information highway from becoming a open sewer. Regular e-mail and open access chat rooms are generally not secure. Although there are some screening tools and blockages that can be employed, as a general matter, the flow of information cannot be adequately controlled in a open environment.

Through community based filtered and monitored systems, such as is described in a Provisional Patent Application No: ______, teachers can set up accounts for themselves and for their classes in order to provide “shared learning” through collaboration. However, this limits the collaborative environment to those who are willing to use the Internet and become part of a community. Moreover, to the extent that there is any financial burden or cost involved with the account, teachers may be reluctant to bear that obligation personally, inasmuch as it is being used for their professional activities. Similarly, establishing such an account may or may not be consistent with the curriculum plans for a particular school or for the particular school system. Classrooms in wealthier areas may all be interconnected, while those is less affluent parts of a community may not, thus relying on those teachers to bear any economic cost of setting up and maintaining the account, along with the computer necessary to access it.

Entire school systems are coming to the realization that they much provide uniform access to all of the teachers within the system. To do so internally can be prohibitive. Setting up the necessary servers, personal computers and information system infrastructure in this time of budget constraints can delay or prevent appropriate integration of technology and information into the classroom. Maintaining the system from a software and hardware standpoint can be prohibitive, require substantial personnel and, given the rapid advances in both, result in the system becoming obsolete almost before it comes on line. Having a dedicated system for a school district may also be highly inefficient, depending on the size of the district. Outsourcing such an endeavor may have similar drawbacks and cause a district and its administrator to lose control over its information system. Similarly, such outsourcing can result in information being accessed by students which may not be appropriate for their age, maturity and sex, among other criteria.

It is vital that an enterprise, be it a school or a business, be able to have its constituent parts communicate with one another in real time, provide information and obtain flow both internally and from without, be secure and provide a level of filtering and monitoring consistent with the objectives of the enterprise. In the case of a school district, it is important that the schools have access to information, be able to access a “class room” community for “share learning” and provide a level on filtering and monitoring consistent with the particular requirement of a given class or group of students. At the same time, intra-class and intra-school communication is necessary to permit the rapid dissemination of information, whether time sensitive or recipient sensitive, in an efficient manner.

### DESCRIPTION OF THE METHOD AND SYSTEM

The method and system for multi-level monitoring and filtering of data transmissions (Schoolmail) permits the creation of a school district or school system secure “virtual district” with “virtual classrooms”, “virtual meeting halls”, “virtual teacher conferences” and multiple accounts to permit a hierarchical infrastructure with varying privileges associated with each user name or category. The system provides a universal solution to allowing information flow to both students and educators, while maintaining control of the type and character of material received by students. It also permits internal community or group generation to permit dissemination of information to different levels of educators or administrators on a needs basis. The system can employ common server capability to permit multiple districts to have their individual SchoolMail, while at the same time providing the capability of interaction and connectivity among the districts, based upon screening and search criteria. In short, multiple districts can have customized SchoolMail with district and school specific webpages and firewalls prevent unwanted access to data from other districts on the same system. The system can provide filtering and monitoring for both incoming and outgoing data transmissions on multiple levels, such as class specific, school specific and district or region specific. It can also control the desktop of the personal computers that on the SchoolMail system to prevent students from getting off and onto an open and uncontrolled system.

The hierarchy within the system was created to permit the easy management of every aspect of the SchoolMail system:

Systems administrators

Reseller administrators

District administrators

School administrators

Monitors

Students

Every level of the hierarchy can control the levels below. When new accounts are created, they inherit the attributes of the levels above. Within each level, there can be multiple sub-levels with attributes of levels both above and below, depend on the person who is responsible for creating the account. For example, a district administrator can create an account for a school administrator which would permit that school administrator to have access and control over certain monitoring functions ie. Profanity monitoring, but would not permit access to other functions, ie. Administrative communications.

The dynamic filtering permits security to be controlled from a centralized location and ties the individual classrooms into a network. The filtering level component permits each lower level on the hierarchical pyramid within the network to be monitored to a degree that is administrator designated and appropriate for that level, be it students, teachers or lower level administrators. The system is designed to permit a monitor at a given level to receive a copy of messages that are sent or received in an account. The monitor can be a teacher who has a number of classrooms, a guidance counselor who is given a designated number of students, or a teacher who is working with a group of students on a project not necessarily as part of a formal classroom. The flagging filter component of the system will scan each message sent or received for words that are on a master flagged word list. If a word on the master flagged word list is found in the message, the message is routed to the monitor's account and will not be released until the monitor has reviewed it and authorized its delivery or transmittal.

The master flagged word list is capable of modification and customization in accordance with the dictates of the administrator responsible for the system or to a designated monitor or monitors to whom that responsibility has been assigned. By providing a hierarchical model and control pyramid, access levels can be customized. Access can be limited or opened to classrooms, school districts, or even open access to the entire Internet community. Inappropriate words and phrases can be added or deleted from e-mail monitoring criteria. Monitors can close student accounts based upon pre-set criteria, while maintaining the incoming e-mails for future release to the student when the account is reopened.

The hierarchical nature of the entire system permits flexibility in filtration, monitoring, delivery of information and collaboration between students, teachers, administrators and different segments of the educational universe. It permits the monitoring function to be similarly customized and controlled by the administrator, with complete flexibility in the designation of surrogate administrator/monitors with access to such levels as the primary administrator designates. The system also allows administrators, or their designees, to send e-mail messages to any segment of the school or district, including teachers and students.

The system permits administrators to assign monitors to students at any time and can be modified to allow teachers and parents or multiple teachers to cooperatively monitor a student or group of students. The access control permits the administrator at any level to restrict e-mail access for any or all users at that level and below. Access can be limited to:

Users who have the same monitor (eg. class teacher).

Users in the same school.

Users in the same community or district.

Any SchoolMail users.

Any users who are part of the larger server community.

The Internet (unrestricted access).

Users are unable to send or receive mail from beyond the limits set and outsiders trying to send e-mail to restricted users will receive a “bounce” message that the intended recipient cannot receive mail from outside the restricted area. While other systems that filter e-mail offer only an “on” or “off” option, SchoolMail permits the administrator or designee to define the level of filtration and control in order to make it easier to manage the workload associated with monitoring. By way of example, the filtering levels may be:

Level 1—the monitor must approve every message sent or received.

Level 2—the monitor receives a copy of every message sent or received, but must approve only those which contain words that are on the Master Flagged List.

Unflagged messages can be delivered to their recipient.

Level 3—the monitor will only receive messages that are flagged by the filter system.

Level 4—the filters are not employed (communications between teachers or administrators.

These filter levels are exemplary only and can be modified to permit different combinations of monitoring. The filters and monitoring can be applied to any group of users down to the individual level.

Another filtering component permits the centralized location to monitor all communications designated for a discussion board before the communication is posted. This dynamic filtering system also can be administrator designated and employs a master flagged word list. However the monitoring function is centralized and the administrator or their designee is not burdened with having to review flagged messages for posting. In the event there is a flagged message which is not appropriate for posting, the message is routed to the monitor for appropriate action regarding the originating student.

Another important aspect of the dynamic filtering system is that attachments are also reviewed in order to control any improper transmittal of data to a student. The dynamic filtering system will scan the attachment against the master flagged word list or any customized version of that list and will also determine if there is an photographic material. In the event that there is either of the above, based upon the monitor designated filtering criteria, the attachment and the e-mail to which it was attached are flagged and forwarded to the monitor's account for review.

Yet another feature of the filtering system permits the scanning of the text of any e-card that is sent to or from a monitored account. In other educational systems, when an e-card was sent to or from a monitored account, only a notification with a link to the actual card was sent to the monitor. SchoolMail actually scans the text of the e-card that is referenced in the url in the notification, thus permitting e-cards that contained material designated in the Master Flagged List to be previewed and blocked by a monitor, even if the notification itself gives no indication that the e-card may be inappropriate.

The centralized filtering system permits coordination of filtration between members in a community, revision by individuals, who are designated by the administrator, of monitoring criteria and implementation of those revisions, creation of additional accounts for students, teachers, special project groups, etc. in order to permit multiple access and different levels of filtration and unique community building within the overall network. SchoolMail has the unique feature, not found in any other current educational system, of an embedded bi-directional filter which can be adjusted and employed in a multi-level, hierarchical manner over a broad, shared system.

SchoolMail permits account creation in batches where numerous fields can be customized per user and will allow the file import of data instead of just form input. It has flexible import options and permits the properties at any given level to be inherited from higher in the hierarchy. The system also permits navigation within account lists which allows for jumping to any page or directly to the last or first page of a listing. It is also customizable to permit each school or subdivision, as specified by the administrator or their designee, to have its own Homepage, activities pages and other unique, school or class specific pages.

SchoolMail also permits a search to be conducted over several pages. Its “Select All” function operates across all pages, thereby selecting every account that matches the requested search. This permits an administrator or a designated person to perform a search and select all of the resultant account in order to change attributes for all selected accounts. In addition, items on any page in the search can be deselected or reselected and a user can locate another user several pages deed and deselect that user, rather than permitting only the selection of the limited items that are visible.

SchoolMail also permits an administrator to define access privileges for users for any application as well as any files. This function consists of first defining the resource to which to apply the access, then identifying the users to whom the administrator wishes to grant access and finally defining the terms of the access itself. This is applicable to student groups who wish to have forums, teachers who want discussion boards, administrators who need to discuss supervisory issues, etc. The administrator at the level can create the account, grant access and establish the moderation or monitoring function centrally, without having to reconfigure the system or obtain new programs, software or hardware.

To further enhance the collaborative aspect of the learning experience, SchoolMail also permits file sharing and storage. By defining a “classroom”, whether an actual class of students, a common interest group, a project group or a collaborative, multi-school or multi-national assembly of students and teachers, SchoolMail permits the administrator to allow files to be share within the defined “classroom”. The access control is integrated into the file sharing function to enable the administrator to define the level of access to files, folders and the users to whom access is granted. SchoolMail File Storage and Sharing is an Internet-based file storage system fully integrated into the SchoolMail environment. It allows users to save, store and access their important files from any computer with an Internet connection, whether in the classroom, the school computer lab, the library, or from home. File Storage and Sharing makes it easy for users to store and distribute a wide variety of materials to their students and colleagues. Anything a user can save on their computer can be shared with members of the school community. In addition, students can use the file sharing tool to submit their materials to their teachers for review. Teachers and Administrators can make files available to everyone in their school(s), or send files directly to any user.

Through the user interface, a student, teacher or other person who has been granted access to the “classroom” can go to the link “My Files” and have presented first their private folder and from there they can navigate to other folders available to them or perform other actions. The user privileges associated with the File Sharing can be separated into those for teachers, administrators and students. Administrators and designated teachers can have shared as well as private folders. Files in a shared folder are available to any user within the “classroom” to which they are assigned. Teachers who are designated as monitors can view the files in any of their student's private folders, but they cannot delete or otherwise manipulate those files. Teachers and administrators can upload or move files of any user within their monitoring level into the school's private folder. Teachers or designated monitors have access to the private folders of their students.

Similarly, students can have private and shared folders. The students can store their own files within their private folders and they can move files to any teacher or administrator's private space, but, as part of the overall monitoring functionality, cannot transfer files directly to any other student. The system also permits students to view the shared folders of any teacher or administrator who is assigned to their “classroom”, “school” or “group”. An example of the operation SchoolMail File Storing and Sharing is appended as Exhibit A.

SchoolMail also permits the targeting and creation of a desired community. The system functions as a search engine to contact specified users from within the larger community and allows the administrator or other designated person to send announcements, newsletters or other messages that are user specific. Thus, a message can be targeted to those who need the information, while not distributing messages that won't be read. Moreover, the messages are no actually sent to users until they log in. This feature minimizes server load and reduces waste in bandwidth that would result from the general dissemination of thousands of messages to users who would not be interested in the information and would not read the message.

We claim:

1. An apparatus for multi-level monitoring and filtering data transmission to screen unwanted material comprising a hierarchical infrastructure for initially screening data to create a varying degrees of accessibility to input data, a dynamic search engine to permit those members of the community to search the data initially screened within the limit permitted by the hierarchical infrastructure, a dynamic filter controlled by a central location to permit monitoring and filtering of the data transmitted and structuring of the infrastructure and a flagging filter component to scan messages and data prior to delivery.
